(19) United States
(12) Patent Application Publication
(10) Pub. No.: US 2007/0081535 A1
(43) Pub. Date: Apr. 12, 2007

(54) Method and system for implementing virtual router redundacy protocol on a resilient packet ring

(75) Inventor: Jian Li, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., Ltd., Shenzhen (CN)

(21) Appl. No.: 11/542,964

(22) Filed: Oct. 4, 2006

(30) Foreign Application Priority Data
Oct. 8, 2005 (CN) 200510106585.6

(51) Int. Cl. H04L 12/56

(52) U.S. Cl. 370/392; 370/401

(57) ABSTRACT

A method for implementing Virtual Router Redundancy Protocol (VRRP) on a Resilient Packet Ring (RPR), including: setting an interface supporting a plurality of Medium Access Control (MAC) addresses for each RPR interface of network devices to constitute VRRP groups; classifying the RPR interfaces of network devices to constitute VRRP groups, and the interfaces supporting a plurality of MAC addresses, into one virtual local area network (VLAN); running the VRRP in the classified VLAN to generate at least one virtual layer 3 switch device. Also, the present invention discloses a system for implementing VRRP on an RPR. In the method and system of the present invention, a plurality of virtual layer 3 switch devices are generated by means of setting a VE interface in the network device and running the VRRP in the VLAN which contains both the VE interface and the RPR interface.

This application claims priority to Chinese Patent Application No. 200510106585.6, filed Oct. 8, 2005, which is hereby incorporated by reference.

1. Field of the Invention

The present invention relates to routing technologies, and particularly, to a method and system for implementing Virtual Router Redundancy Protocol (VRRP) on a Resilient Packet Ring.

2. Background of the Invention

FIG. 1 illustrates the architecture of a system for implementing a Virtual Router Redundancy Protocol (VRRP) on a Resilient Packet Ring (RPR) in the prior art. As shown in FIG. 1, the RPR includes a network device A11, a network device B12, a network device C13, a network device D14, a network device E15 and a network device F16. The network devices from A11 to F16 can support the RPR protocol, and an RPR interface of each network device may support two work modes, namely a routing mode and a bridge mode respectively. The routing mode means to bear an IP service or an MPLS service etc. on the RPR interface; the bridge mode means to bear an Ethernet service on the RPR interface. The network device shown in FIG. 1 may be a router or a layer 3 switch which can support the RPR protocol.

As shown in FIG. 1, through running the VRRP on the RPR interfaces of both the network device A11 and the network device B12, the network device A 11 and the network device B12 may constitute a VRRP group with a virtual RPR interface.

For the network devices from C13 to F16, the VRRP group constituted by the network device A11 and the network device B12 is equal to a virtual layer 3 switch device 17 which can implement functions of a layer 3 switch or a router. Correspondingly, the virtual RPR interface is similar to a default gateway of the virtual layer 3 switch device 17. The network devices from C13 to F16 on the RPR can communicate with other networks through the RPR interface of the virtual layer 3 switch device 17. The RPR has a topology structure of dual-ring with opposite directions, and both of the two ringlets of the RPR, which are called RPR0 and RPR1, can transfer data. As shown in FIG. 2, the RPR0 transmits data in a clockwise direction, whereas the RPR1 transmits data in a counter-clockwise direction. Each network device on the RPR adopts a 48-bit Medium Access Control (MAC) address of the Ethernet as an address identifier of the device.

The VRRP has the following functions: selecting one or more routers in a network to constitute at least one VRRP group, which can be seen as a virtual router for those devices not constituting any VRRP group. As shown in FIG. 3, host A, B, and C in the Ethernet communicate with the Internet through router A, B, and C, respectively. After the VRRP is run at the router A, B, and C, the router A, B, and C can constitute a VRRP group equal to a virtual router, then hosts in the Ethernet can communicate with the Internet via this virtual router.

In the prior art, after a set of network devices constitute a VRRP group by running the VRRP, each network device in the VRRP group can generate a virtual MAC address and an IP address based on the VRRP. According to the IEEE802.17 protocol, besides supporting the MAC address of the RPR itself, the RPR interface of the network device on the RPR can support at most two other MAC addresses. Thus, the network device can constitute at most two VRRP groups, and generate two virtual layer 3 switch devices. Consequently, when there is a need to generate a plurality of virtual layer 3 switch devices by running the VRRP in order to provide multifunctional services and larger transmission bandwidth, the method of the prior art is unable to meet this network requirement. Moreover, after the set of network devices on the RPR ring have generated a virtual layer 3 switch device based on the VRRP, restricted by the VRRP, it will take at least three seconds for a backup node of the virtual layer 3 switch device to detect a failure of the master node and perform a master/backup switch. The slow speed of master/backup switch can not satisfy the requirements of some real-time services. Here, after a plurality of network devices constitute a VRRP group, a network device need to be appointed as the master node of the VRRP group, and the master node is mainly in charge of switch in layer 3 for the virtual layer 3 switch device, so the master node is also called the master node of the virtual layer 3 switch device. Other network devices in the VRRP group are all backup nodes, and when the master node can not work normally, a certain backup node will substitute for the master node to fulfill the primary work of the virtual layer 3 switch device.

### SUMMARY

The invention is to provide a method and system for implementing Virtual Router Redundancy Protocol on a Resilient Packet Ring, so as to generate a plurality of virtual routers on the RPR based on the VRRP.

The technical scheme of this invention is implemented as follows:

A method for implementing Virtual Router Redundancy Protocol (VRRP) on a Resilient Packet Ring (RPR), including: setting an interface supporting a plurality of Medium Access Control (MAC) addresses for each RPR interface of network devices to constitute VRRP groups;

classifying the RPR interfaces of network devices to constitute VRRP groups, and the interfaces supporting a plurality of MAC addresses, into one virtual local area network (VLAN);

running the VRRP in the classified VLAN to generate at least one virtual layer 3 switch device.

A system for implementing Virtual Router Redundancy Protocol (VRRP) on a Resilient Packet Ring (RPR), network devices of which connecting with each other via an RPR include RPR interfaces;

wherein the network devices further include interfaces configured to support a plurality of MAC addresses; and

classifying the RPR interfaces of the network devices to constitute a VRRP group, and the interfaces supporting multiple MAC addresses into one VLAN, and running the VRRP on the classified VRRP to generate at least one virtual layer 3 switch device.

It can be seen from the above solution that, in accordance with the method of the present invention, which is for implementing VRRP on a Resilient Packet Ring, a Virtual Ethernet (VE) interface is set on the RPR for network devices which are about to constitute VRRP groups, and all the VE interfaces of the network devices constituting the VRRP groups and the RPR interfaces will be classified into a same virtual local area network (VLAN). Then, the VRRP will be run in the classified VLAN, so as to implement the VRRP on the RPR. In addition, because the VE interface set in the network device can support multiple MAC addresses, a plurality of VRRP groups can be generated on the RPR simultaneously according to this method, so that the RPR may possess a plurality of virtual layer 3 switch devices.

Furthermore, the present invention provides a system for implementing VRRP on an RPR, where the RPR interfaces of network devices in the system are configured to support the bridge mode, and the VE interfaces are set in the network devices constituting VRRP groups. Then, the VRRP will be run at the VE interfaces, so that a plurality of VRRP groups can be generated on the RPR.

### BRIEF DESCRIPTION OF THE DRAWINGS

FIG. 1 is a schematic diagram illustrating the architecture of a system for implementing VRRP on a Resilient Packet Ring in accordance with the prior art;

FIG. 2 is a schematic diagram illustrating a topology structure of the RPR in accordance with the prior art;

FIG. 3 is a schematic diagram constituting a virtual router using the VRRP;

FIG. 4 is a flowchart for implementing VRRP on a Resilient Packet Ring according to an embodiment of the present invention;

FIG. 5 is a schematic diagram illustrating the architecture of a system for implementing VRRP on an RPR according to an embodiment of the present invention.

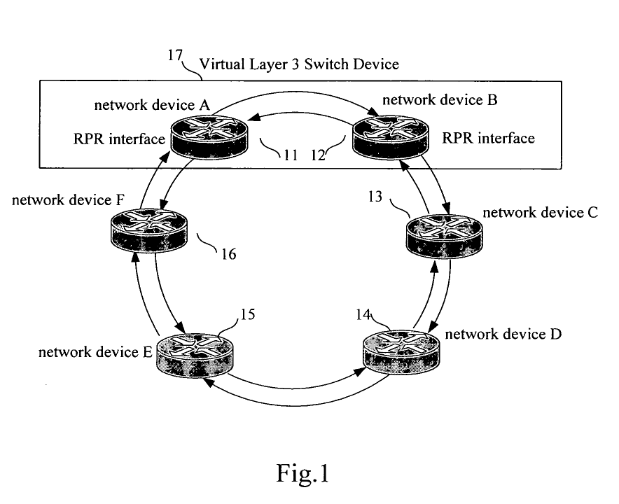

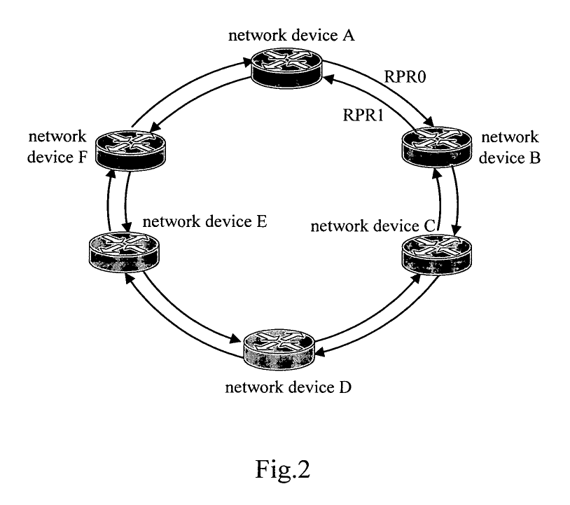

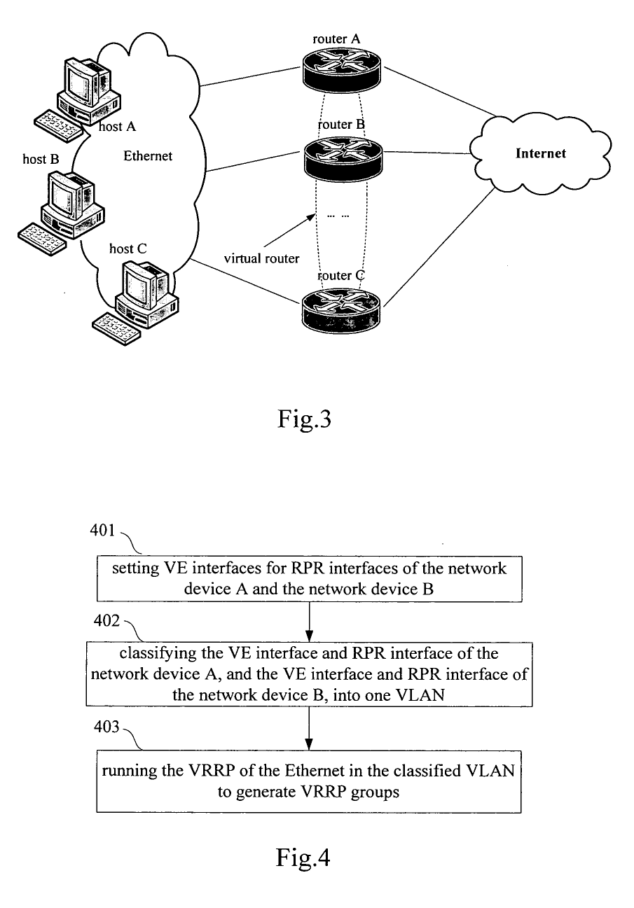

### EMBODIMENTS OF THE INVENTION

In a preferred embodiment of the present invention, an interface that can support a plurality of MAC addresses is set on an RPR interface of a network device on an RPR, and the interface supporting a plurality of MAC addresses and the RPR interface are classified into a same VLAN, and then a VRRP is run in the classified VLAN, so as to implement a plurality of virtual layer 3 switch devices on the RPR.

In this embodiment, the interface which can support a plurality of multiple MAC addresses is a VE interface. Since the VE interface is required to be set on the RPR interface of the network device on the RPR, the RPR interface of the network is required to support the bridge mode. The specific reason is as follows: all messages transmitted from the VE interface are layer 2 Ethernet messages, and if the RPR interface is in the routing mode, these messages can not be born on the RPR directly; while network devices in the bridge mode can encapsulate layer 2 Ethernet messages in accordance with the RPR protocol, and bear the messages transmitted from the VE interface onto the RPR.

As shown in FIG. 4, the embodiment is described in detail taking the process of how two network devices on the RPR, assuming they are network device A and network device B, constitute three virtual layer 3 switch devices as an example. Before constituting the virtual layer 3 switch devices, all the RPR interfaces of network devices on the RPR are configured to support the bridge mode based on the VRRP. The network devices include network device A and network device B.

Step 401: setting corresponding VE interfaces for RPR interfaces of the network device A and the network device B. The characteristic of a VE interface is the same as that of an Ethernet interface, i.e., can support a plurality of MAC addresses simultaneously.

In the step, the method of setting the VE interface includes: adding a piece of record into an interface index table of the network device for the VE interface, and configuring the MAC address and the IP address of the VE interface, so that other devices can access or operate the VE interface.

Step 402: classifying the VE interface and RPR interface of the network device A, and the VE interface and RPR interface of the network device B, into one VLAN.

After finishing the step, the VE interfaces and RPR interfaces of both the network device A and the network device B are subject to the same VLAN. Once a broadcast message for the VLAN appears, the VE interfaces and RPR interfaces of both the network device A and the network device B can receive this message.

Step 403: setting corresponding group identifiers and IP addresses for these three VRRP groups to be constituted, and running the VRRP of the Ethernet in the classified VLAN to generate these three VRRP groups, so as to generate three virtual layer 3 switch devices. The three virtual switch devices use the preset group identifiers and IP addresses.

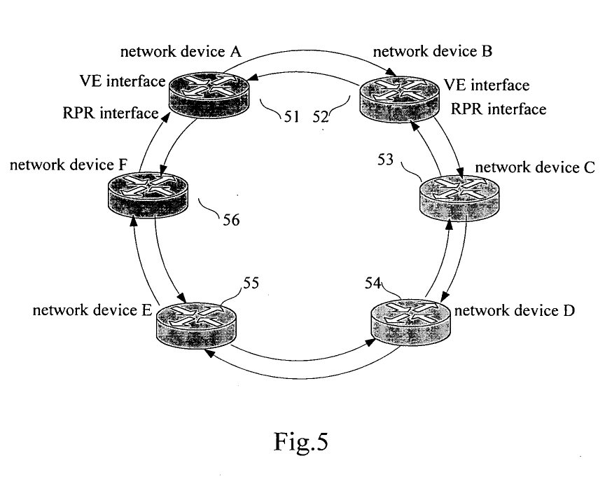

FIG. 5 is the architecture of a system for implementing VRRP on an RPR in an embodiment of the present invention. Similarly, the process of how two network devices on the RPR, assuming they are network device A and network device B, constitute three virtual layer 3 switch devices is taken as an example for the detailed description of the systematic architecture of this embodiment shown in FIG. 5. The system includes: a network device A51, a network device B52, a network device C53, a network device D54, a network device E55 and a network device F56. Here, the network devices from A51 to F56 connect with each other via the RPR, and the RPR interfaces of network devices from A51 to F56 are configured to support the bridge mode. As shown in FIG. 5, each of the network devices A and B has a VE interface. The VE interface and RPR interface of network device A, and the VE interface and RPR interface of network device B are classified into a same VLAN. Afterwards, three group identifiers and IP addresses will be configured respectively, and the VRRP of the Ethernet will be run in the classified VLAN so as to constitute the three corresponding VRRP groups.

Similar to the flowchart as shown in FIG. 4 and the system in FIG. 5, when two network devices are required to constitute an arbitrary number of VRRP groups and virtual layer 3 switch devices, it is only needed to set corresponding number of group identifiers and IP addresses and run the VRRP in the classified VLAN. If it is required to constitute one or more VRRP groups composed of a plurality of network devices on the RPR, the method as shown in FIG. 4 can also be used for reference, that is, setting VE interfaces in a plurality of network devices to constitute a VRRP group, classifying the RPR interfaces and the VE interfaces of these network devices into a same VLAN, setting one or more group identifiers and IP addresses based on the VRRP, and running the VRRP in the classified VLAN, so as to constitute the one or more VRRP groups and virtual layer 3 switch devices.

The RPR described in the embodiment has six network devices, and in practical applications, it may have a random number of network devices on the RPR. In this case, the method and system for setting multiple VRRP groups on the RPR to generate multiple virtual layer 3 switch devices are similar to those of the present embodiment, which are not further discussed here.

After the VRRP is implemented on the RPR according to the method of the present embodiment, another method is further provided for performing a master/backup switch in the VRRP group, which refers to the operation that nodes in a connected domain of the VRRP group negotiate with each other to generate a master node. Here, the connected domain means an area in which each node can interchange information and services with one another. When a node failure appears in the VRRP group or nodes in each connected domain of the VRRP group change, and a new connected domain comes forth or the structure of an old connected domain changes, the previous master node in a certain connected domain is likely to be invalid, or there are multiple master nodes in the connected domain. Then, a master/backup switch is required in the connected domain to select a new master node through negotiation.

The change of the topology structure of the RPR leads to two cases in a certain connected domain: first, at least one master node is added in this connected domain; second, the previous master node is invalid so that there is no master node in the connected domain.

In the case when at least one master node is newly-added to the connected domain, all the master nodes existing in the connected domain will send VRRP advertisement messages on the RPR. If a certain master node in the connected domain does not receive a VRRP advertisement message sent from other master nodes, it is proved that there is only one master node in this connected domain, thus a master/backup switch is not necessary. Meanwhile, each backup node in the connected domain will record the MAC address of the RPR interface of the master node based on the VRRP. If a certain master node in the connected domain has received a VRRP advertisement message sent from other master nodes, all the master nodes in the connected domain will negotiate with each other in accordance with the VRRP to determine a new master node, then other nodes which are not determined to be the new master node will register the MAC address of the RPR interface of the new master node.

In the case when the previous master node in a certain connected domain is invalid, each backup node in the connected domain will check the topology table saved in itself, and judge whether the present topology table contains the MAC address of the RPR interface of the previous master node. If it does, it indicates that the previous master node in the connected domain is not out of work, and a master/backup switch is not necessary. If it doesn't, it indicates that the previous master node in the connected domain is invalid, then the backup nodes may choose a new master node through negotiation in accordance with the VRRP, and other nodes which are not determined to be the new master node will register the MAC address of the RPR interface of this new master node.

After detecting the failure of the master node in the connected domain according to the VRRP, the 50 ms topology convergence characteristic of the RPR can be used to speed up the master/backup switch. Here, the 50 ms topology convergence characteristic means that all the network devices on the RPR can collect topology information on the RPR within 50 ms, and perform a master/backup switch in accordance with the collected topology information.

To sum up, the foregoing is only a preferred embodiment of this invention, and it is not used to limit the protection scope thereof. Any changes and modifications may be made by those skilled in the art in light of the present invention without departing from its spirit and scope and therefore will be covered by the protection scope as set by the appended claims.

1. A method for implementing Virtual Router Redundancy Protocol (VRRP) on a Resilient Packet Ring (RPR), comprising: setting an interface supporting a plurality of Medium Access Control (MAC) addresses for each RPR interface of network devices to constitute VRRP groups;
classifying the RPR interfaces of network devices to constitute VRRP groups, and the interfaces supporting a plurality of MAC addresses, into one virtual local area network (VLAN);
running the VRRP in the classified VLAN to generate at least one virtual layer 3 switch device.

2. The method according to claim 1, wherein the RPR interface of the network device on the RPR supports a bridge mode; and the interface supporting a plurality of MAC addresses is a Virtual Ethernet (VE) interface.

3. The method according to claim 2, wherein when a master node in the VRRP group detecting that the topology structure of the RPR changes, the method further comprises: the master node sending a VRRP advertisement message, and after the master node receiving a VRRP advertisement message sent from any of the other master nodes, negotiating a new master node from all the nodes in the VRRP group based on the VRRP, and registering the MAC address of the RPR interface of the new master node by the other nodes which are not determined to be the new master node.

4. The method according to claim 2, further comprising: a backup node of the VRRP group registering the MAC address of the RPR interface of the master node; and when the topology structure of the RPR changes, checking whether the MAC address of the RPR interface of the master node exists in the topology table of the backup node; if it does, performing no process; if it doesn't, the backup node determining that the master node is invalid, and negotiating with other backup nodes to select a new master node based on the VRRP, and registering the MAC address of the RPR interface of the new master node by the other nodes which are not determined to be the new master node.

5. The method according to claim 1, wherein when a master node in the VRRP group detecting that the topology structure of the RPR changes, the method further comprises: the master node sending a VRRP advertisement message, and after the master node receiving a VRRP advertisement message sent by other master nodes, negotiating a new master node from all the nodes in the VRRP group based on the VRRP, and registering the MAC address of the RPR interface of the new master node by the other nodes which are not determined to be the new master node.

6. The method according to claim 1, further comprising: a backup node of the VRRP group registering the MAC address of the RPR interface of the master node; and when the topology structure of the RPR changes, checking whether the MAC address of the RPR interface of the master node exists in the topology table of the backup node; if it does, performing no process; if it doesn't, the backup node determining that the master node is invalid, and negotiating with other backup nodes to select a new master node based on the VRRP, and registering the MAC address of the RPR interface of the new master node by the other nodes which are not determined to be the new master node.

7. A system for implementing Virtual Router Redundancy Protocol (VRRP) on a Resilient Packet Ring (RPR), network devices of which connecting with each other via an RPR comprise RPR interfaces;
wherein the network devices further comprise interfaces configured to support a plurality of MAC addresses; and
classifying the RPR interfaces of the network devices to constitute a VRRP group, and the interfaces supporting multiple MAC addresses into one VLAN, and running the VRRP on the classified VRRP to generate at least one virtual layer 3 switch device.

8. The system according to claim 7, wherein the interface supporting a plurality of MAC addresses is a Virtual Ethernet (VE) interface.
